(19) United States
(12) Patent Application Publication
(10) Pub. No.: US 2022/0027713 A1
(43) Pub. Date: Jan. 27, 2022

(54) MULTI-FUNCTION CALCULATOR AND OPERATION METHOD THEREOF

(71) Applicant: I-SHOU UNIVERSITY, Kaohsiung City (TW)

(72) Inventors: Yu-Jung Huang, Kaohsiung City (TW); Shao-I Chu, Kaohsiung City (TW); Meng-Jhe Li, Tainan City (TW); Wun-Siou Jhong, Kaohsiung City (TW)

(73) Assignee: I-SHOU UNIVERSITY, Kaohsiung City (TW)

(21) Appl. No.: 16/986,273

(22) Filed: Aug. 6, 2020

(30) Foreign Application Priority Data
Jul. 24, 2020 (TW) 109125060

(51) Int. Cl. G06N 3/063; G06N 3/04

(52) U.S. Cl. CPC G06N 3/063; G06N 3/04

(57) ABSTRACT

A multi-function calculator suitable for a neural network architecture is provided. The multi-function calculator includes a plurality of activation function operation circuits and a demultiplexer (DMUX). The plurality of activation function operation circuits are configured to execute a plurality of different activation functions on an input signal respectively. The DMUX is coupled to the plurality of activation function operation circuits. The DMUX is configured to receive an enable signal and a selection signal. The DMUX in an enabled state selects one of the plurality of activation function operation circuits to be enabled according to the selection signal. The enabled activation function operation circuit executes a corresponding activation function on the input signal to generate a corresponding output signal.

### CROSS-REFERENCE TO RELATED APPLICATION

This application claims the priority benefit of Taiwan application serial no. 109125060, filed on Jul. 24, 2020. The entirety of the above-mentioned patent application is hereby incorporated by reference herein and made a part of this specification.

### BACKGROUND OF THE INVENTION

### 1. Field of the Invention

The disclosure relates to a multi-function calculator, and more particularly, to a multi-function calculator suitable for a neural network architecture.

### 2. Description of Related Art

Deep learning is a branch of machine learning. Deep learning is an algorithm that uses an artificial neural network (ANN) as an architecture to characterize and learn data. In the application of deep learning and neural networks, an activation function plays an important role. The activation function is a scalar-to-scalar function used to calculate an activation value of neurons. The purpose is to introduce nonlinear characteristics into modeling capabilities of networks. The activation function is used to forwardly transmit an output of nodes of each layer to a next layer until it reaches an output layer. Commonly used activation functions include an S-type (sigmoid) function, a tanh function, a softmax function, and a rectified linear unit (ReLU) function.

Each layer of the neural network may use different activation functions. The activation function that is preset to be used may be implemented as hardware using a hardware description language (HDL) or other suitable programming languages, that is, an activation function operation circuit. However, the activation function is fixed after being implemented as the hardware. In other words, even if the calculation accuracy is poor, other types of activation functions can no longer be used. In addition, the existing activation function operation circuit also lacks versatility for different neural network architectures.

Therefore, it is necessary to propose a solution for the lack of flexibility and versatility of the activation function operation circuit.

### SUMMARY OF THE INVENTION

The disclosure provides a multi-function calculator with flexibility and versatility.

The multi-function calculator of the disclosure is suitable for a neural network architecture. The multi-function calculator includes a plurality of activation function operation circuits and a demultiplexer (DMUX). The plurality of activation function operation circuits are configured to execute a plurality of different activation functions on an input signal respectively. The DMUX is coupled to the plurality of activation function operation circuits. The DMUX is configured to receive an enable signal and a selection signal. The DMUX in an enabled state selects one of the plurality of activation function operation circuits to be enabled according to the selection signal. The enabled activation function operation circuit executes a corresponding activation function on the input signal to generate a corresponding output signal.

An operation method of a multi-function calculator of the disclosure is suitable for a neural network architecture. The foregoing operation method includes the following steps. The multi-function calculator is provided. The multi-function calculator includes a plurality of activation function operation circuits and a DMUX. The plurality of activation function operation circuits are configured to execute a plurality of different activation functions on an input signal respectively. The DMUX receives an enable signal, such that the DMUX is in an enabled state. The DMUX receives a selection signal, such that the DMUX in the enabled state selects one of the plurality of activation function operation circuits to be enabled according to the selection signal. The enabled activation function operation circuit executes a corresponding activation function on the input signal to generate a corresponding output signal.

In an embodiment of the disclosure, each of the plurality of activation functions is a linear function or a nonlinear function.

In an embodiment of the disclosure, the plurality of activation function operation circuits are constructed by a plurality of finite-state machine (FSM) control circuits respectively.

In an embodiment of the disclosure, the plurality of activation functions are implemented as the plurality of activation function operation circuits using an HDL.

In an embodiment of the disclosure, the plurality of activation functions include at least one of a sigmoid function, a tanh function, a softmax function, and an ReLU function.

Based on the above, in the disclosure, by implementing a plurality of activation functions on hardware and matching a DMUX, a neural network may be flexibly switched between a plurality of activation function operation circuits during operation. Also, the activation function originally set for each layer may be changed through a selection signal. Therefore, the multi-function calculator constructed by the disclosure has flexibility and versatility.

### BRIEF DESCRIPTION OF THE DRAWINGS

FIG. 1A shows a schematic application diagram of a multi-function calculator of the disclosure.

FIG. 1B shows a schematic structure diagram of a single node in a hidden layer.

FIG. 2 shows a schematic block diagram of a multi-function calculator of the disclosure.

FIG. 3 shows a schematic architecture flow diagram of an activation function operation circuit of the disclosure.

FIG. 4 shows a schematic architecture flow diagram of an activation function operation circuit of the disclosure.

FIG. 5 shows a schematic architecture flow diagram of an activation function operation circuit of the disclosure.

FIG. 6 shows a step flow chart of an operation method of a multi-function calculator of the disclosure.

### DESCRIPTION OF THE EMBODIMENTS

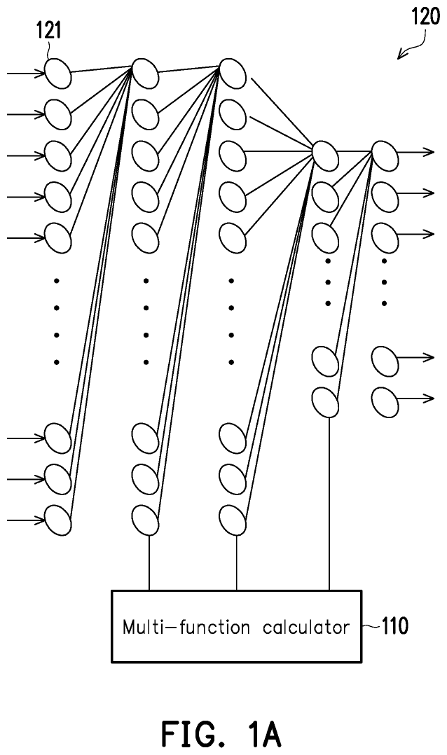

FIG. 1A shows a schematic application diagram of a multi-function calculator of the disclosure. The multi-function calculator is suitable for a neural network architecture. Referring to FIG. 1A, a multi-function calculator 110 is coupled to a plurality of nodes (i.e., neurons) 121 in a neural network 120. For example, the neural network 120 may have five layers, and each layer has a plurality of nodes 121. The first and fifth layers are used as an input layer and an output layer, respectively, and the second to fourth layers are hidden layers. It should be noted that, in order to keep the diagram concise, FIG. 1A only shows the multi-function calculator 110 and one node 121 of each layer in the hidden layer. In fact, the multi-function calculator 110 is coupled to all nodes 121 of each layer in the hidden layer. The multi-function calculator 110 is configured to provide the same or different activation functions for each node 121 in the hidden layer.

FIG. 1B shows a schematic structure diagram of a single node in a hidden layer. As shown in FIG. 1B, an input signal of each node 121 in the hidden layer will be calculated by a conversion function (represented by a mathematical operator Σ) and an activation function A to generate an output signal. A net input of the activation function A is a dot product of a weight (denoted as W₀, W₁, W₂, . . . , Wₙ) and input features (denoted as X₀, X₁, X₂, . . . , Xₙ), and the activation function A is applied to output acquisition and fed as an input to one or more nodes in the next layer. The activation function A may be a linear function or a nonlinear function. The same or different activation functions A may be used between the nodes 121 on the same layer. In the case where the nodes 121 of the same layer all use the same activation function A, the same or different activation functions A may be used between all layers.

In terms of hardware, the activation function may be implemented in a logic circuit on an integrated circuit. The related functions of the activation function may be implemented as hardware using an HDL (such as Verilog HDL or VHDL) or other suitable programming languages. For example, the related functions of the activation function may be constructed by an FSM control circuit and implemented in one or more controllers, micro-controllers, micro-processors, application-specific integrated circuits (ASIC), digital signal processors (DSP), field programmable gate arrays (FPGA), and/or various logic blocks, modules and circuits in other processing units.

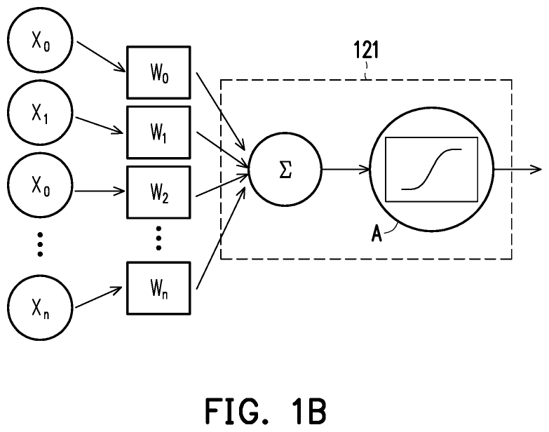

FIG. 2 shows a schematic block diagram of a multi-function calculator of the disclosure. As shown in FIG. 2, the multi-function calculator 200 includes a plurality of activation function operation circuits 210 (including 211 to 213) and a DMUX. The plurality of activation function operation circuits 210 are configured to execute a plurality of different activation functions on an input signal z respectively. The input signal z is a general term for net inputs of activation functions of a plurality of nodes. The DMUX 220 is coupled to the foregoing plurality of activation function operation circuits 210, and the DMUX 220 may receive an enable signal EN and a selection signal SE. The DMUX 220 may be in an enabled state according to the enable signal EN. The DMUX 220 in the enabled state may select one of the plurality of activation function operation circuits 210 to be enabled according to the selection signal SE.

For example, a user may pre-determine three layers to use a sigmoid function, a tanh function, and an ReLU function for operation, respectively. When a signal is transmitted to a plurality of nodes in the first layer, the DMUX 220 in the enabled state may select the activation function operation circuit 211 to be enabled according to the selection signal SE to generate an output signal Sz. When a signal is transmitted to a plurality of nodes in the second layer, the DMUX 220 in the enabled state may select the activation function operation circuit 212 to be enabled according to the selection signal SE to generate an output signal Tz. Similarly, when a signal is transmitted to a plurality of nodes in the third layer, the DMUX 220 in the enabled state may select the activation function operation circuit 213 to be enabled according to the selection signal SE to generate an output signal Rz. When one activation function calculation circuit is enabled, the remaining activation function calculation circuits are all disabled.

It should be noted that although only the sigmoid function, the tanh function, and the ReLU function are listed above, the disclosure is not limited thereto. In practical applications, the plurality of activation functions executed by the plurality of activation function operation circuits 210 may be selected from linear functions, sigmoid functions, tanh functions, hard tanh functions, softmax functions, ReLU functions, leaky ReLU functions, and Softplus functions.

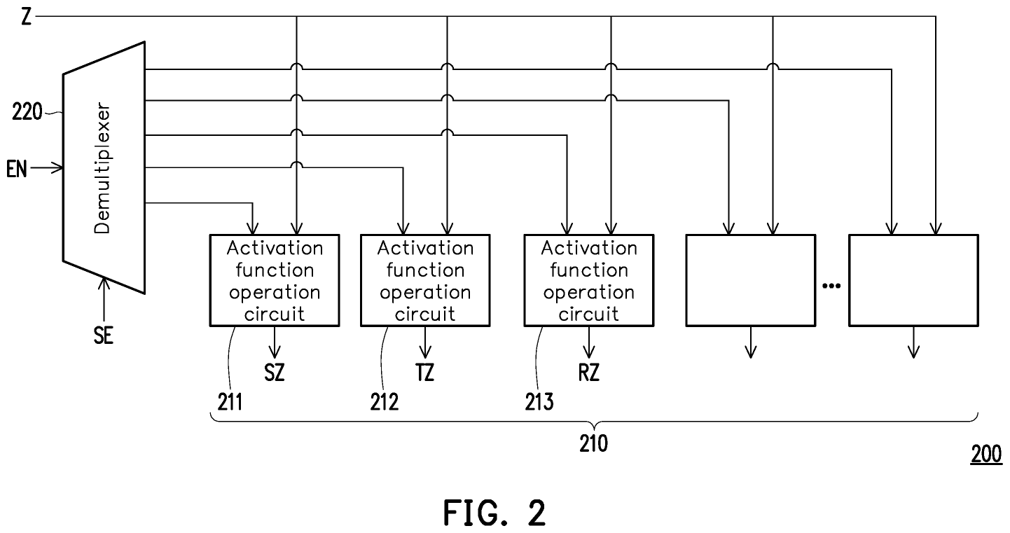

By implementing a plurality of activation functions on hardware and matching a DMUX, a neural network may be flexibly switched between a plurality of activation function operation circuits during operation. And the activation function originally set for each layer may be changed through a selection signal in the case of poor calculation accuracy. Therefore, the multi-function calculator constructed by the disclosure has versatility for any type of neural network architecture. The details of implementing a plurality of activation functions using a coordinate rotation digital computer (CORDIC) technology and applying a floating-point format (single-precision IEEE754 standard) will be described below with reference to FIGS. 3-5.

FIG. 3 shows a schematic architecture flow diagram of an activation function operation circuit of the disclosure. Based on a CORDIC rotation mode, the characteristics of trigonometric functions may be quickly calculated in hardware, and an activation function operation circuit that may execute a sigmoid function is designed. As shown in FIG. 3, an activation function operation circuit 300 uses an FSM control circuit to achieve a calculation function of the sigmoid function.

First, input signals z and 1/k′ are received. The input signal z is a general term for net inputs of activation functions of a plurality of nodes. The input signal 1/k′ is a result of the input signal z obtained based on a CORDIC algorithm. Signals Xn, Yn, and Zn are generated according to the input signals z and 1/k′. The signal Xn is provided to a shifter S1 and a floating-point adder FP_ADD1. An output signal of the shifter S1 is provided to a floating-point adder FP_ADD2. The signal Yn is provided to a shifter S2 and the float adder FP_ADD2. The floating-point adder FP_ADD1 performs a floating-point addition operation on the signal Xn and an output signal of the shifter S2, and generates an output signal X_out to be provided to a floating-point adder FP_ADD4 and a register R1. The output signal X_out of the floating-point adder FP_ADD1 is returned to the FSM control circuit through the register R1. In addition, the signal Zn and a signal from a data table T1 according to a table look-up instruction are used as an input of a floating-point adder FP_ADD3 to generate a signal Z_out. The signal Z_out is returned to the FSM control circuit via a register R3.

The floating-point adder FP_ADD2 performs an operation on the signal Yn and the output signal of the shifter S1, and generates an output signal Y_out to be provided to the floating-point adder FP_ADD4 and a register R2. The output signal Y_out of the floating-point adder FP_ADD2 is returned to the FSM control circuit through the register R2. The floating-point adder FP_ADD4 performs a floating-point addition operation on the output signals of the floating-point adders FP_ADD1 and FP_ADD2 and generates an output signal. The output signal of the floating-point adder FP_ADD4 is negative, subjected to an exponential function operation (denoted as e^{-Z}) and then provided to a floating-point adder FP_ADD5. In addition, 1 is used as another input signal of the floating-point adder FP_ADD5. The floating-point adder FP_ADD5 performs a floating-point addition operation on the signal after e^{-Z} operation and 1 to generate an output signal. A floating-point divider FP_DIV1 performs a floating-point division operation on the output signal of the floating-point adder FP_ADD5 and 1 to generate an output signal Sz.

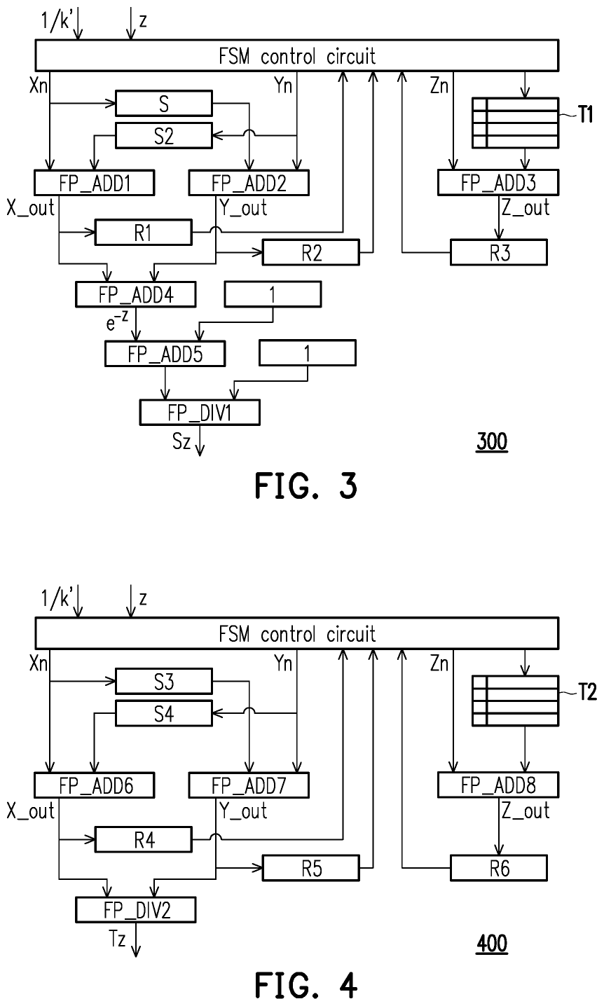

FIG. 4 shows a schematic architecture flow diagram of an activation function operation circuit of the disclosure. Based on a CORDIC rotation mode, the characteristics of trigonometric functions may be quickly calculated in hardware, and an activation function operation circuit that may execute a tanh function is designed. As shown in FIG. 4, an activation function operation circuit 400 uses an FSM control circuit to achieve a calculation function of the tanh function.

First, input signals z and 1/k′ are received. The input signal z is a general term for net inputs of activation functions of a plurality of nodes. The input signal 1/k′ is a result of the input signal z obtained based on a CORDIC algorithm. Signals Xn, Yn, and Zn are generated according to the input signals z and 1/k′. The signal Xn is provided to a shifter S3 and a floating-point adder FP_ADD6. An output signal of the shifter S3 is provided to a floating-point adder FP_ADD7. The signal Yn is provided to the floating-point adder FP_ADD7 and a shifter S4. An output signal of the shifter S4 is provided to the floating-point adder FP_ADD6. The floating-point adder FP_ADD6 performs a floating-point addition operation on the signal Xn and an output signal of the shifter S4, and obtains an output signal X_out. The floating-point adder FP_ADD7 performs a floating-point addition operation on the output signal of the shifter S3 and the signal Yn to obtain an output signal Y_out. The output signals X_out and Y_out are returned to the FSM control circuit through registers R4 and R5 respectively. In addition, the signal Zn and a signal from a data table T2 according to a table look-up instruction are used as an input of a floating-point adder FP_ADD8 to generate an output signal Z_out. The output signal Z_out is returned to the FSM control circuit through a register R6. A floating-point divider FP_DIV2 performs a floating-point division operation on the output signals X_out and Y_out to obtain an output signal Tz.

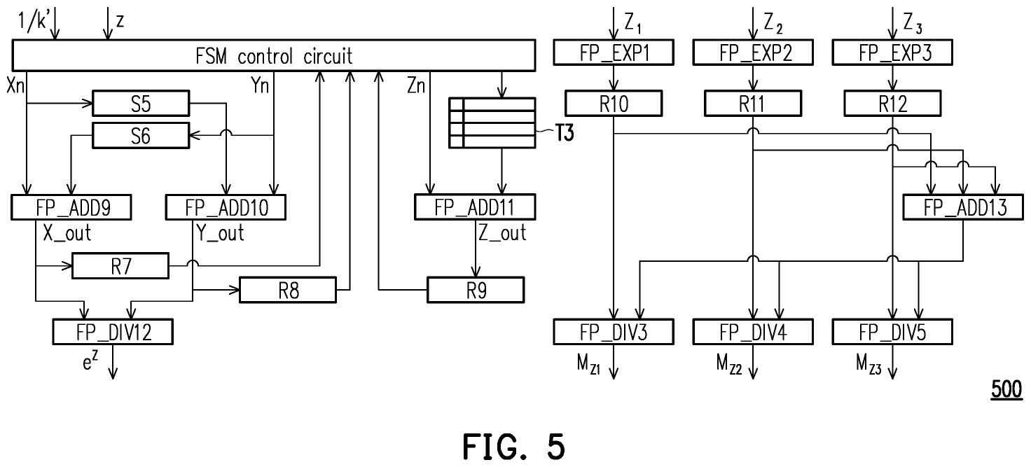

FIG. 5 shows a schematic architecture flow diagram of an activation function operation circuit of the disclosure. As shown in FIG. 5, an activation function operation circuit 500 uses an FSM control circuit to achieve a calculation function of a softmax function.

First, input signals z and 1/k′ are received. The input signal z is a general term for net inputs of activation functions of a plurality of nodes. The input signal 1/k′ is a result of the input signal z obtained based on a CORDIC algorithm. Signals Xn, Yn, and Zn are generated according to the input signals z and 1/k′. The signal Xn is provided to a shifter S5 and a floating-point adder FP_ADD9. An output signal of the shifter S5 is provided to a floating-point adder FP_ADD10. The signal Yn is provided to the floating-point adder FP_ADD10 and a shifter S6. An output signal of the shifter S6 is provided to the floating-point adder FP_ADD9. The floating-point adder FP_ADD9 performs a floating-point addition operation on the signal Xn and an output signal of the shifter S6, and obtains an output signal X_out. The floating-point adder FP_ADD10 performs a floating-point addition operation on the output signal of the shifter S5 and the signal Yn to obtain an output signal Y_out. The output signals X_out and Y_out are returned to the FSM control circuit through registers R7 and R8 respectively. In addition, the signal Zn and a signal from a data table T3 according to a table look-up instruction are used as an input of a floating-point adder FP_ADD11 to generate an output signal Z_out. The output signal Z_out is returned to the FSM control circuit through a register R9. A floating-point adder FP_ADD12 performs a floating-point addition operation on the output signals X_out and Y_out to obtain an output signal.

The output signal of the floating-point adder FP_ADD12 undergoes an exponential function (denoted as e^{Z}) to generate signals Z1-Z3 (the number corresponds to the classification of the problems). The signals Z1 to Z3 are subjected to floating-point exponential calculators FP_EXP1 to FP_EXP3 respectively to generate three output signals. The output signals of the floating-point exponential calculators FP_EXP1 to FP_EXP3 are provided to floating-point dividers FP_DIV3 to FP_DIV5 via registers R9 to R12, respectively. The output signals of the floating-point exponential calculators FP_EXP1 to FP_EXP3 are provided to a floating-point adder FP_ADD13 via registers R9 to R12, respectively. The floating-point adder FP_ADD13 performs a floating-point addition operation on the output signals of the registers R9 to R12, and the result of the operation is provided to the floating-point dividers FP_DIV3 to FP_DIV5. The floating-point divider FP_DIV3 performs a floating-point division operation on the output signal of the register R10 and the output signal of the floating-point adder FP_ADD13 to obtain an output signal Mz1. The floating-point divider FP_DIV4 performs a floating-point division operation on the output signal of the register R11 and the output signal of the floating-point adder FP_ADD13 to obtain an output signal Mz2. The floating-point divider FP_DIV4 performs a floating-point division operation on the output signal of the register R12 and the output signal of the floating-point adder FP_ADD13 to obtain an output signal Mz3. The output signals Mz1 to Mz3 reflect a probability. In short, in order to keep an output result positive, the output is mapped to a real number between 0 and 1, and normalized to ensure that the sum is 1. In other words, the sum of the probabilities is also exactly 1.

Table (1) is a value comparison table in an IEEE binary floating-point arithmetic standard (IEEE 754). A first row of Table (1) represents operation results generated by using the technology of the disclosure. In the first row, the input is a 32-bit value 0x3FC90FDB. The foregoing input may obtain an output result 0x3F6ACA7F by the multi-function calculator of the disclosure (selecting an activation function operation circuit enabled to execute a tanh function). The foregoing input may obtain an output result 0x3F53F10F by the multi-function calculator of the disclosure (selecting an activation function operation circuit enabled to execute a sigmoid function). The foregoing input may obtain an output result 0x3FC90FDB by the multi-function calculator of the disclosure (selecting an activation function operation circuit enabled to execute an ReLU function).

TABLE 1

| | Input | Tanh | Sigmoid | ReLU |
|---|---|---|---|---|
| IEEE754 | 0x3fc90fdb | 0x3f6aca7f | 0x3f53f10f | 0x3fc90fdb |
| Float | 1.5707964 | 0.91715235 | 0.827897 | 1.5707964 |
| Software | 1.5707964 | 0.91715234729 | 0.82789711 | 1.5707964 |

The foregoing operation result is expressed in a second row in a float mode. A third row is a result generated by performing operations on the same input using software (for example, Python). It can be seen from Table (1) that values in the second row and the third row are almost the same, which shows the high calculation accuracy of the disclosure.

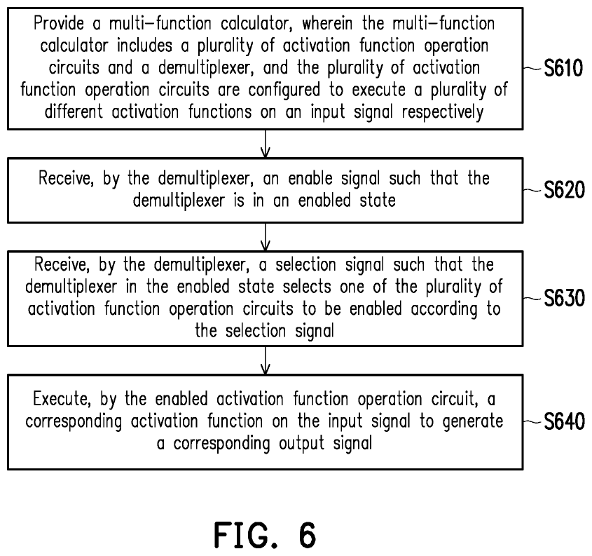

FIG. 6 shows a step flow chart of an operation method of a multi-function calculator of the disclosure. The operation method of the multi-function calculator is suitable for a neural network architecture. Referring to FIGS. 2 and 6 simultaneously, the foregoing operation method includes: providing a multi-function calculator 200, wherein the multi-function calculator 200 includes a plurality of activation function operation circuits 210 and a DMUX 220, and the plurality of activation function operation circuits 210 are configured to execute a plurality of different activation functions on an input signal z respectively (step S610); receiving, by the DMUX 220, an enable signal EN such that the DMUX is in an enabled state (step S620); receiving, by the DMUX 220, a selection signal SE such that the DMUX 220 in the enabled state selects one of the plurality of activation function operation circuits 210, for example, the activation function operation circuit 211, to be enabled according to the selection signal SE (step S630); and executing, by the enabled activation function operation circuit (for example, 211), the corresponding activation function on the input signal z to generate a corresponding output signal (step S640).

Based on the above, in the disclosure, by implementing a plurality of activation functions on hardware and matching a DMUX, a neural network may be flexibly switched between a plurality of activation function operation circuits during operation. And the activation function originally set for each layer may be changed through a selection signal in the case of poor calculation accuracy. Therefore, the multi-function calculator constructed by the disclosure has versatility for any type of neural network architecture, and may achieve the best convergence effect.

What is claimed is:

1. A multi-function calculator suitable for a neural network architecture, comprising:
a plurality of activation function operation circuits, configured to execute a plurality of different activation functions on an input signal respectively; and
a demultiplexer (DMUX), coupled to the plurality of activation function operation circuits, wherein the DMUX is configured to receive an enable signal and a selection signal, such that the DMUX in an enabled state selects one of the plurality of activation function operation circuits to be enabled according to the selection signal,
wherein the enabled activation function operation circuit executes a corresponding activation function on the input signal to generate a corresponding output signal.

2. The multi-function calculator according to claim 1, wherein each of the plurality of activation functions is a linear function or a nonlinear function.

3. The multi-function calculator according to claim 1, wherein the plurality of activation function operation circuits are constructed by a plurality of finite-state machine (FSM) control circuits respectively.

4. The multi-function calculator according to claim 1, wherein the plurality of activation functions are implemented as the plurality of activation function operation circuits using a hardware description language (HDL).

5. The multi-function calculator according to claim 1, wherein the plurality of activation functions comprise at least one of an S-type (sigmoid) function, a tanh function, a softmax function, and a rectified linear unit (ReLU) function.

6. An operation method of a multi-function calculator suitable for a neural network architecture, the operation method comprising:
providing the multi-function calculator, wherein the multi-function calculator comprises a plurality of activation function operation circuits and a DMUX, and the plurality of activation function operation circuits are configured to execute a plurality of different activation functions on an input signal respectively;
receiving, by the DMUX, an enable signal, such that the DMUX is in an enabled state;
receiving, by the DMUX, a selection signal, such that the DMUX in the enabled state selects one of the plurality of activation function operation circuits to be enabled according to the selection signal; and
executing, by the enabled activation function operation circuit, a corresponding activation function on the input signal to generate a corresponding output signal.

7. The operation method of the multi-function calculator according to claim 6, wherein each of the plurality of activation functions is a linear function or a nonlinear function.

8. The operation method of the multi-function calculator according to claim 6, wherein the plurality of activation function operation circuits are constructed by a plurality of FSM control circuits respectively.

9. The operation method of the multi-function calculator according to claim 6, wherein the plurality of activation functions are implemented as the plurality of activation function operation circuits using a HDL.

10. The operation method of the multi-function calculator according to claim 6, wherein the plurality of activation functions comprise at least one of an S-type (sigmoid) function, a tanh function, a softmax function, and an ReLU function.
